(19) United States
(12) Patent Application Publication
(10) Pub. No.: US 2019/0129030 A1
(43) Pub. Date: May 2, 2019

(54) DISTANCE SENSING APPARATUS

(71) Applicants: LITE-ON ELECTRONICS (GUANGZHOU) LIMITED, GUANGZHOU (CN); Lite-On Technology Corporation, Taipei (TW)

(72) Inventor: Bing-Han Sung, Taipei (TW)

(73) Assignees: LITE-ON ELECTRONICS (GUANGZHOU) LIMITED, GUANGZHOU (CN); Lite-On Technology Corporation, Taipei (TW)

(21) Appl. No.: 15/866,435

(22) Filed: Jan. 9, 2018

(30) Foreign Application Priority Data
Oct. 30, 2017 (CN) 201711031827.9

(51) Int. Cl. G01S 17/08; G01S 7/00; G01S 7/48; G01S 7/481; G02B 7/00

(52) U.S. Cl. CPC G01S 17/08; G01S 7/003; G02B 7/005; G01S 7/481; G01S 7/4808

(57) ABSTRACT

A distance sensing apparatus is provided. The distance sensing apparatus includes an optical distance measuring device, a rotating device, and a wireless signal transmitter. The optical distance measuring device is configured to obtain original data. The rotating device is disposed on a first side of the optical distance measuring device. The rotating device includes a bearer, the optical distance measuring device is disposed on the bearer, and the rotating device is configured to rotate the optical distance measuring device via the bearer. The wireless signal transmitter is coupled to the optical distance measuring device, disposed on a second side of the optical distance measuring device, and configured to transmit a signal including the original data. The first side of the optical distance measuring device is different from the second side thereof.

### CROSS REFERENCE TO RELATED APPLICATION

This application claims the priority benefit of China application serial no. 201711031827.9, filed on Oct. 30, 2017. The entirety of the above-mentioned patent application is hereby incorporated by reference herein and made a part of specification.

### BACKGROUND OF THE INVENTION

### Field of the Invention

The invention is related to a distance sensing apparatus.

### Description of Related Art

Lidar device has been widely applied in market. For example, in the field of cleaning robot and self-driving vehicle, the lidar device with characteristic of high accuracy is used mainly to show surrounding environment and state to achieve the purpose of avoiding obstacles and planning routes.

In order to achieve high resolution and a viewing angle of 360 degrees, one of the common methods used by the lidar device is to utilize a hollow motor and a rotating platform to carry a laser transceiving module, and a control circuit is configured to control the motor and the rotating platform, thereby rotating the laser transceiving module. With such design, a signal obtained by the laser transceiving module can be transmitted to the control circuit of the lidar device via the hollow motor and a hollow tube of the rotating platform. However, the mechanical design with a hollow structure is more complicated and increases manufacturing costs.

Another common approach is to utilize a mechanical ring to carry and rotate the laser transceiving module. With an electrode disposed on the mechanical ring, the signal obtained by the laser transceiving module can be transmitted to the control circuit of the lidar device. However, the friction between a stator and a rotor of the mechanical ring causes the service life of the mechanical ring to decrease; however, if a mercury ring is used to solve the friction problem, the manufacturing cost would be increased.

Accordingly, it is an important issue to figure out how to design a mechanical structure that is low-cost and simple to transmit the signal obtained by the laser transceiving module in the lidar device to the control circuit to solve the problem of high costs for the current lidar device.

### SUMMARY OF THE INVENTION

The invention provides a distance sensing apparatus with a simple mechanical structure and low manufacturing costs and the service life thereof can be maintained.

In the invention, the distance sensing apparatus includes an optical distance measuring device, a rotating device and a wireless signal transmitter. The optical distance measuring device is configured to obtain original data. The rotating device is disposed on a first side of the optical distance measuring device. The rotating device includes a bearer, the optical distance measuring device is disposed on the bearer, and the rotating device is configured to rotate the optical distance measuring device via the bearer. The wireless signal transmitter is coupled to the optical distance measuring device, disposed on a second side of the optical distance measuring device, and configured to transmit a signal including the original data. The first side of the optical distance measuring device is different from the second side thereof.

In order to make the aforementioned features and advantages of the disclosure more comprehensible, embodiments accompanying figures are described in detail below.

### BRIEF DESCRIPTION OF THE DRAWINGS

FIG. 1 is a schematic view illustrating a structure of a distance sensing apparatus according to an embodiment of the invention.

FIG. 2A is a schematic side view illustrating an optical distance measuring device according to an embodiment of the invention.

FIG. 2B is a schematic top view illustrating an optical distance measuring device according to an embodiment of the invention.

FIG. 3 is a schematic view illustrating a structure of a distance sensing apparatus according to another embodiment of the invention.

FIG. 4A is a schematic side view illustrating a wireless signal transmitter and a wireless charging receiver according to another embodiment of the invention.

FIG. 4B is a schematic top view illustrating a wireless signal transmitter and a wireless charging receiver according to another embodiment of the invention.

### DESCRIPTION OF EMBODIMENTS

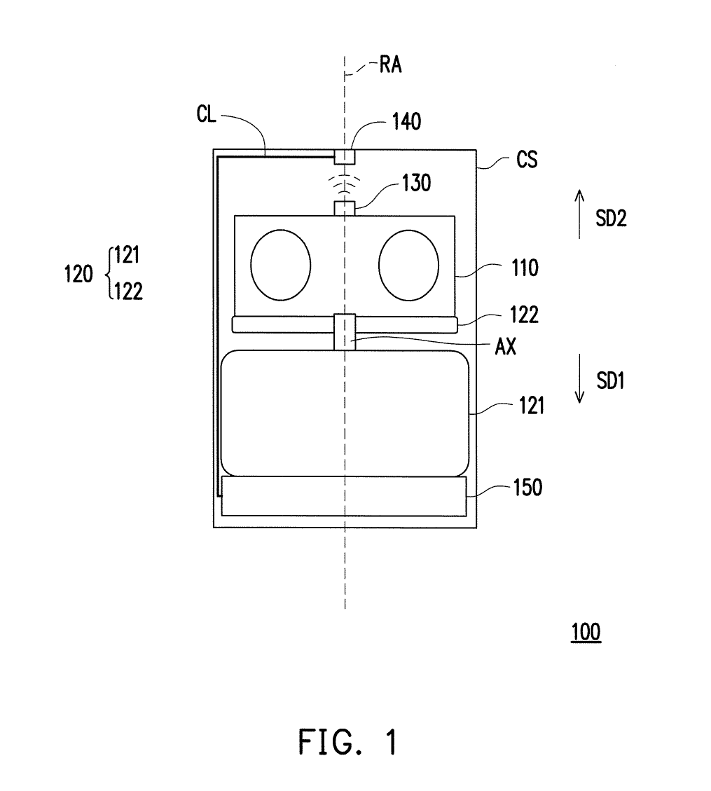

FIG. 1 is a schematic view illustrating a structure of a distance sensing apparatus according to an embodiment of the invention.

Referring to FIG. 1, in the embodiment, a distance sensing apparatus 100 includes an optical distance measuring device 110, a rotating device 120, a wireless signal transmitter 130, a wireless signal receiver 140 and a control circuit 150, and each of the above-mentioned devices is accommodated in a housing CS. In an embodiment, the distance sensing apparatus 100 is, for example, realized as a lidar device, and the control circuit 150 thereof is coupled to the rotating device 120 and the wireless signal receiver 140, configured to control the rotating device 120 to rotate and receive the signal from the wireless signal receiver 140.

The optical distance measuring device 110 is configured to obtain original data corresponding to distances or depths. In an embodiment, the optical distance measuring device 110 is, for example, a laser transceiving device configured to transmit a laser pulse. The laser pulse is reflected after hitting an object surface so that the optical distance measuring device 110 can receive the reflected laser pulse. In the embodiment, the original data, for example, corresponds to two time points at which the laser pulse is transmitted and received, and a time difference of the two time points may correspond to a time of flight (TOF) of photon. In this manner, the distance between the optical distance measuring device 110 and the object can be calculated based on the time of flight of photon in cooperation with light velocity.

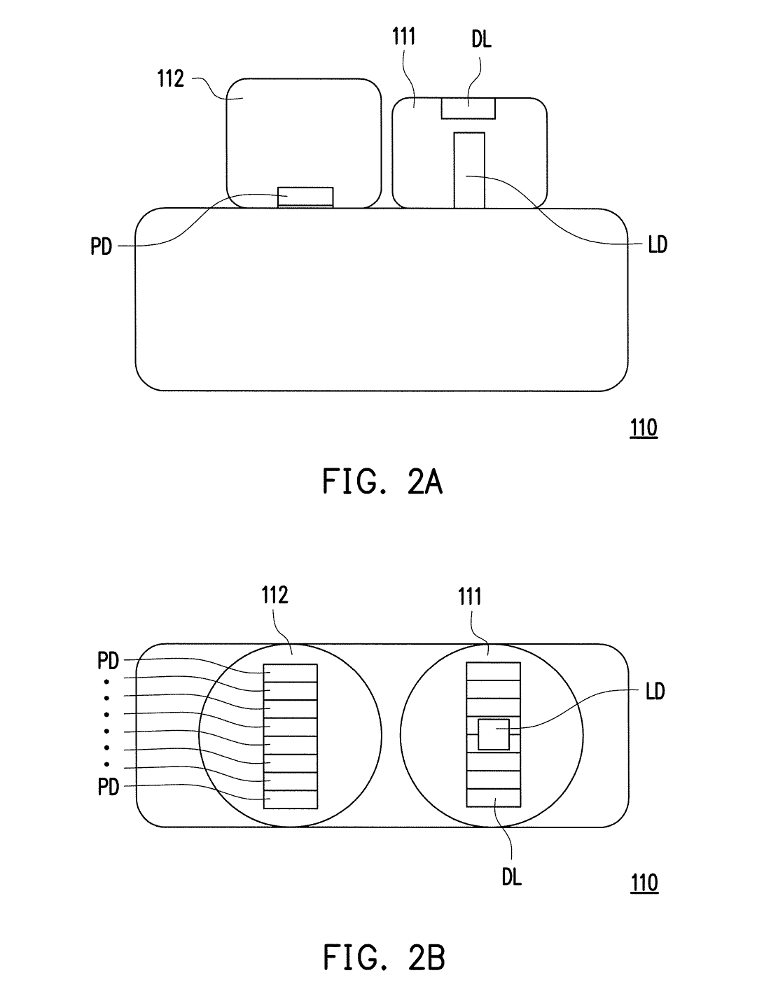

FIG. 2A is a schematic side view illustrating an optical distance measuring device according to an embodiment of the invention. FIG. 2B is a schematic top view illustrating an optical distance measuring device according to an embodiment of the invention.

Referring to FIG. 2A and FIG. 2B, in the embodiment, the optical distance measuring device 110 is, for example, constructed by an optical transmitting device 111 and an optical receiving device 112. The optical transmitting device 111 includes, for example, a laser diode LD and a diffuser lens DL. The laser pulse transmitted by the laser diode LD is diffused by the diffuser lens DL to form a plurality of (for example but not limited to, 16) laser pulses. The optical receiving device 112 is, for example, a photodiode array (for example but not limited to, 1*16 array) that includes a plurality of photodiodes PD (for example but not limited to, 16), and is configured to receive a plurality of reflected laser pluses generated after the plurality of laser pulses formed via the diffuser lens are reflected after hitting the object surface. With the diffuser lens DL of the embodiment, the optical receiving device 112 can diffuse one laser pulse transmitted by one laser diode LD into a plurality of laser pulses to save the amount of laser diode LD.

However, the invention provides no limitation to the specific implementation and data form of the optical distance measuring device 110 and the obtained original data. In other embodiment, the optical distance measuring device 110 may, for example, use a structural light or a different approach to obtain the original data corresponding to the distances or depths. Persons of ordinary skill in the art can realize the optical distance measuring device 110 depending on the need to obtain the original data.

The rotating device 120 is connected to the optical distance measuring device 110 and configured to rotate the optical distance measuring device 110, which may include, for example, a combination of a motor and a rotating platform, but the invention is not limited thereto. In an embodiment, the rotating device 120 includes a motor 121 and a bearer 122 used as a rotating plate, wherein the motor 121 is connected to the bearer 122 via an axle AX and the optical distance measuring device 110 is fixed on the bearer 122. Therefore, when the motor 121 is activated, the motor 121 can drive the optical distance measuring device 110 to rotate about a rotating axis RA via the bearer 122. It should be pointed out that the rotating axis RA refers to an axis of rotation about which the optical distance measuring device 110 is rotated instead of a physical device.

The wireless signal transmitter 130 is coupled to the optical distance measuring device 110, configured to receive original data from the optical distance measuring device 110, and transmits a signal including the original data. In an embodiment, the wireless signal transmitter 130 is electrically connected to (e.g., via a physical conducting wire) the optical distance measuring device 110 to receive the original data of the optical distance measuring device 110, which should not be construed as a limitation to the invention.

The wireless signal receiver 140 is coupled to the control circuit 150, configured in correspondence to the wireless signal transmitter 130 to receive the signal including the original data from the wireless signal transmitter 130, and transfers the signal to the control circuit 150. In an embodiment, the wireless signal receiver 140 and the control circuit 150 are, for example, two independent devices which are connected to each other via a physical conducting wire, which should not be construed as a limitation to the invention. In another embodiment, the wireless signal receiver 140 may be, for example, integrated with the control circuit 150 to be realized as a whole.

The wireless signal receiver 140 and the wireless signal transmitter 130 are compatible with the same wireless communication band and protocol. In an embodiment, the wireless signal transmitter 130 is, for example, an infrared transmitter, and the wireless signal receiver 140 is, for example, an infrared receiver. In other embodiment, the wireless signal transmitter 130 may be, for example, a Wi-Fi or Bluetooth transmitter, and the wireless signal receiver 140 is, for example, a Wi-Fi or Bluetooth receiver.

The control circuit 150 is configured to receive the signal including the original data from the wireless signal receiver 140, and to convert the original data into distance data. In an embodiment, the control circuit 150 is connected to the motor 121 to control rotating velocity of the motor 121. In an embodiment, the distance sensing apparatus 100 is configured to be disposed on an external electronic apparatus (for example but not limited to, a cleaning robot and so on). The control circuit 150 is further configured to transmit the calculated distance data to the external electronic apparatus.

In the embodiment, the control circuit 150 is disposed on a first side (e.g., corresponding to a lower part of FIG. 1) of the rotating device 120, and the optical distance measuring device 110 is disposed on a second side (e.g., corresponding to an upper part of FIG. 1) of the rotating device 120. Specifically, in the embodiment, the rotating device 120 is disposed on a first side SD1 (e.g., corresponding to the lower part of FIG.1) of the optical distance measuring device 110, and the wireless signal transmitter 130 is disposed on a second side SD2 (e.g., corresponding to the upper part of FIG. 1) of the optical distance measuring device 110. Specifically, relative to the distance sensing apparatus 100, the optical distance measuring device 110 and the wireless signal transmitter 130 are both disposed above the rotating device 120, and the control circuit 150 is disposed under (e.g., the bottom part of the distance sensing apparatus 100) the rotating device 120. With such configuration, the motor 121 and bearer 122 of the rotating device 120 do not need a hollow structure, and the optical distance measuring device 110 can transmit the signal to the control circuit 150 via the wireless signal transmitter 130 and the wireless signal receiver 140.

In an embodiment of the invention, the wireless signal transmitter 130 is, for example, a Wi-Fi or Bluetooth transmitter, and the wireless signal receiver 140 is, for example, a Wi-Fi or Bluetooth receiver. Since the Wi-Fi and Bluetooth signals are wireless signals being not directional, they can be disposed at any position on the distance sensing apparatus 100. For instance, the wireless signal transmitter 130 is, for example, connected to the optical distance measuring device 110 via the conducting wire and fixed on the bearer 122 together with the optical distance measuring device 110. The wireless signal receiver 140 is, for example, integrated in the control circuit 150 to receive the Wi-Fi or Bluetooth signal from the wireless signal transmitter 130.

In another embodiment of the invention, the wireless signal transmitter 130 is, for example, an infrared transmitter, and the wireless signal receiver 140 is, for example, an infrared receiver. As shown in FIG. 1, the wireless signal transmitter 130 is coupled to (e.g., connected via conducting wires) the optical distance measuring device 110 and disposed above the optical distance measuring device 110 through the rotating axis RA. In addition, the wireless signal receiver 140 is attached to an inner side of the top portion of the housing CS, and similarly disposed above the optical distance measuring device 110 through the rotating axis RA. On the other hand, the control circuit 150 is, for example, disposed under the optical distance measuring device 110 and the rotating device 120 (e.g., on the inner side of the bottom portion of housing CS), and connected to the wireless signal receiver 140 via a conducting wire CL attached to the inner side of the housing CS. In this manner, when the optical distance measuring device 110 is rotated along with the rotating device 120, the data can be transmitted to the wireless signal transmitter 130, and the wireless signal transmitter 130 can stably transmit the data to the wireless signal receiver 140 in the form of infrared signal so that the data can be transmitted to the control circuit 150 via the conducting wire CL; it should be noted that the invention is not limited thereto. With the configuration described in the embodiment, the wireless signal transmitter 130 may be a Wi-Fi or Bluetooth transmitter, and the wireless signal receiver 140 may be a Wi-Fi or Bluetooth receiver.

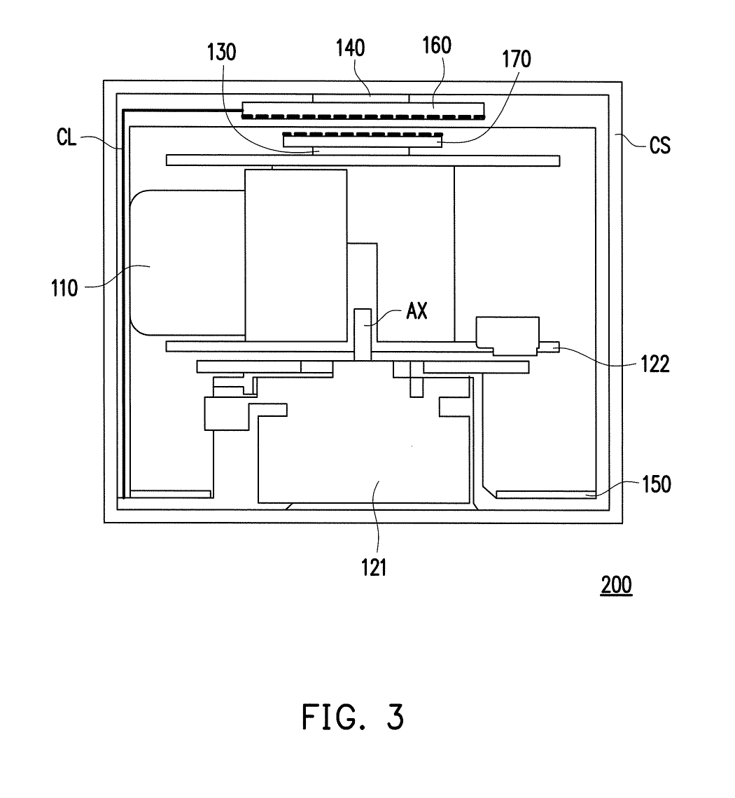

FIG. 3 is a schematic view illustrating a structure of a distance sensing apparatus according to another embodiment of the invention. With the characteristic of the configuration described in the embodiment of FIG. 1, a distance sensing apparatus 200 in the embodiment is further provided with a wireless charging transmitter 160 and a wireless charging receiver 170. In the embodiment, the distance sensing apparatus 200 includes at least the optical distance measuring device 110, the rotating device 120, the wireless signal transmitter 130, the wireless signal receiver 140, the control circuit 150, the wireless charging transmitter 160 and the wireless charging receiver 170, and each of the above-mentioned devices are accommodated in the housing CS. In the embodiment, the same reference numerals as those used in the embodiment of FIG. 1 represent the same elements, and thus no repetition is incorporated herein.

In the embodiment, the wireless charging transmitter 160 and the wireless signal receiver 140 are together attached to the inner side of the top portion of the housing CS, disposed above the optical distance measuring device 110 through the rotating axis RA, and configured to receive a charging power from outside of the housing CS and transmit the charging power to the wireless charging receiver 170. On the other hand, the wireless charging receiver 170 is configured to be disposed in correspondence to the wireless charging transmitter 160, and disposed above the optical distance measuring device 110 together with the wireless signal transmitter 130 through the rotating axis RA. In addition, the wireless charging receiver 170 is further coupled to the optical distance measuring device 110 in a wired or wireless manner, and configured to receive the charging power from the wireless charging transmitter 160 to charge the optical distance measuring device 110. In this manner, even when the optical distance measuring device 110 is rotating, the wireless charging transmitter 160 can also transmit the charging power to the wireless charging receiver 170 to charge the optical distance measuring device 110.

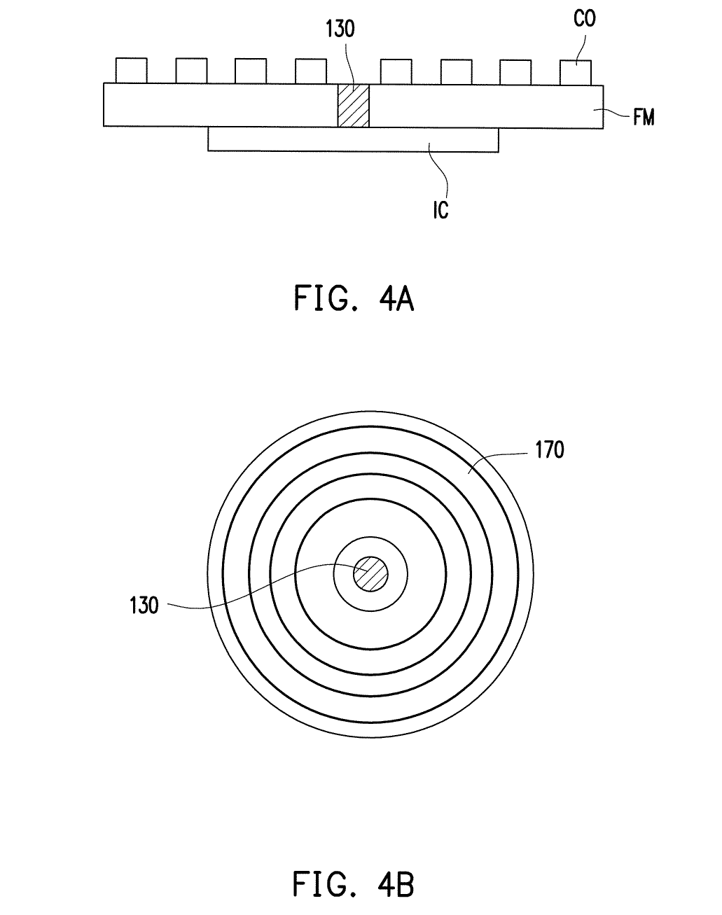

FIG. 4A is a schematic side view illustrating a wireless signal transmitter and a wireless charging receiver according to another embodiment of the invention. FIG. 4B is a schematic top view illustrating a wireless signal transmitter and a wireless charging receiver according to another embodiment of the invention.

In an embodiment, the wireless signal transmitter 130 is, for example, an infrared transmitter, and the wireless signal receiver 140 is, for example, an infrared receiver. The wireless signal transmitter 130 and the wireless charging receiver 170 may be configured in the manner as illustrated in FIG. 4A and FIG. 4B. Specifically, the wireless signal transmitter 130 and the wireless charging receiver 170 in the embodiment are together configured as a three-layer structure. The first layer of the three-layer structure includes a sensing coil CO of the wireless charging receiver 170; the second layer of the three-layer structure includes a disk-like magnetic material FM of the wireless charging receiver 170, where an opening is disposed in the center of the disk-like magnetic material FM; the third layer of the three-layer structure includes the wireless signal transmitter 130 and an circuit IC that controls the wireless charging receiver 170 and the wireless signal transmitter 130. Specifically, the circuit IC is electrically connected to the optical distance measuring device 110 to transmit the signal including original data to the wireless signal receiver 140, or provide power to the optical distance measuring device 110. In the embodiment, the wireless signal transmitter 130 is disposed in the center of the third layer of the three-layer structure to transmit the signal through the opening of the second layer of the three-layer structure.

In another embodiment, the wireless signal transmitter 130 is, for example, a Wi-Fi or Bluetooth transmitter, and the wireless signal receiver 140 is, for example, a Wi-Fi or Bluetooth receiver, and the wireless signal transmitter 130 and the wireless charging receiver 170 may be together configured as a three-layer structure as illustrated in FIG. 4A and FIG. 4B. The difference lies in that, since the Wi-Fi and Bluetooth signals are wireless signals that are not directional, the wireless signal transmitter 130 may be, for example, integrated in the circuit IC, and it is not needed to dispose an opening in the center of the disk-like magnetic material FM on the second layer of the three-layer structure.

It should be mentioned that, on the premise of conforming to the configuration described in the embodiment of FIG. 3, the invention provides no limitation to the specific implementation of wireless charging, and persons of ordinary skill in the art can realize the wireless charging transmitter 160 and the wireless charging receiver 170 of the embodiment by using any kinds of wireless charging technology depending on the need.

It should be noted that, as shown in FIG. 3, the wireless signal transmitter 130 and the wireless charging receiver 170 in the embodiment are disposed above an upper board of the bearer 122; however, the invention is not limited thereto. In other embodiment, the wireless signal transmitter 130 and the wireless charging receiver 170 may be embedded in the upper board of the bearer 122 so as to be rotated along with the optical distance measuring device 110 when the optical distance measuring device 110 is rotated.

In summary, according to the embodiments of the invention, the distance sensing apparatus uses the rotating device with a simple structure to rotate the optical distance measuring device, and uses the wireless signal to transmit the data of the optical distance measuring device to the control circuit. Specifically, the rotating device and the wireless signal transmitter are disposed on both sides of the optical distance measuring device. In this manner, the manufacturing cost of the distance sensing apparatus can be reduced, and the service life of the distance sensing apparatus can be prolonged.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. A distance sensing apparatus, comprising:
an optical distance measuring device, configured to obtain original data;
a rotating device, disposed on a first side of the optical distance measuring device, wherein the rotating device comprises a bearer, the optical distance measuring device is disposed on the bearer, and the rotating device is configured to rotate the optical distance measuring device via the bearer; and
a wireless signal transmitter, coupled to the optical distance measuring device and disposed on a second side of the optical distance measuring device, configured to transmit a signal comprising the original data, wherein the first side of the optical distance measuring device is different from the second side of the optical distance measuring device.

2. The distance sensing apparatus according to claim 1, further comprising:
a control circuit, configured to receive the original data and convert the original data into distance data; and
a wireless signal receiver, coupled to the control circuit, and configured to receive the signal of the original data and transmit the signal to the control circuit.

3. The distance sensing apparatus according to claim 2, wherein the signal is an infrared signal, the rotating device is configured to rotate the optical distance measuring device about a rotating axis via the bearer, and the wireless signal transmitter and the wireless signal receiver are disposed at the rotating axis.

4. The distance sensing apparatus according to claim 3, wherein the control circuit is coupled to the rotating device, disposed under the rotating device, and configured to control the rotating device, wherein the optical distance measuring device is disposed above the rotating device, and the wireless signal transmitter and the wireless signal receiver are disposed above the optical distance measuring device.

5. The distance sensing apparatus according to claim 4, further comprising:
a housing, configured to accommodate the optical distance measuring device, the rotating device, the wireless signal transmitter, the wireless signal receiver and the control circuit, wherein the wireless signal receiver is disposed on an inner side of the housing; and
a conducting wire, attached to the inner side of the housing and configured to connect the wireless signal receiver to the control circuit.

6. The distance sensing apparatus according to claim 2, wherein the optical distance measuring device comprises an optical transmitting device and an optical receiving device, wherein the optical transmitting device comprises:
a laser diode, configured to generate a laser pulse; and
a diffuser lens, disposed on a path of the laser pulse, and configured to diffuse the laser pulse into a plurality of laser pulses.

7. The distance sensing apparatus according to claim 1, wherein the rotating device is configured to rotate the optical distance measuring device about a rotating axis via the bearer, the distance sensing apparatus further comprising:
a housing, configured to accommodate the optical distance measuring device, the rotating device and the wireless signal transmitter;
a wireless charging transmitter, disposed on the housing and configured to transmit a charging power; and
a wireless charging receiver, coupled to the optical distance measuring device to receive the charging power and charge the optical distance measuring device, wherein the wireless charging transmitter and the wireless charging receiver are disposed on the rotating axis above the optical distance measuring device.

8. The distance sensing apparatus according to claim 7, wherein the wireless signal transmitter and the wireless charging receiver are configured as a three-layer structure above the optical distance measuring device,
wherein a first layer of the three-layer structure comprises a sensing coil of the wireless charging receiver, wherein a second layer of the three-layer structure comprises a magnetic material of the wireless charging receiver, wherein a third layer of the three-layer structure comprises the wireless signal transmitter and a circuit,
wherein the circuit is coupled to the wireless signal transmitter, the wireless charging receiver and the optical distance measuring device, configured to control the wireless signal transmitter to transmit the signal comprising the original data, and configured to provide power to the optical distance measuring device via the wireless charging receiver.

9. The distance sensing apparatus according to claim 8, wherein the signal is an infrared signal, and an opening is disposed in a center of the second layer, wherein the wireless signal transmitter is disposed in a center of the third layer to transmit the signal through the opening.

10. The distance sensing apparatus according to claim 2, wherein the rotating device is configured to rotate the optical distance measuring device about a rotating axis via the bearer, the distance sensing apparatus further comprising:
a housing, configured to accommodate the optical distance measuring device, the rotating device and the wireless signal transmitter;
a wireless charging transmitter, disposed on the housing and configured to transmit a charging power; and
a wireless charging receiver, coupled to the optical distance measuring device to receive the charging power and charge the optical distance measuring device, wherein the wireless charging transmitter and the wireless charging receiver are disposed on the rotating axis above the optical distance measuring device.

11. The distance sensing apparatus according to claim 10, wherein the wireless signal transmitter and the wireless charging receiver are configured as a three-layer structure above the optical distance measuring device,
wherein a first structure of the three-layer structure comprises a sensing coil of the wireless charging receiver, wherein a second layer of the three-layer structure comprises a magnetic material of the wireless charging receiver, wherein a third layer of the three-layer structure comprises the wireless signal transmitter and a circuit,
wherein the circuit is coupled to the wireless signal transmitter, the wireless charging receiver and the optical distance measuring device, configured to control the wireless signal transmitter to transmit the signal comprising the original data, and configured to provide power to the optical distance measuring device via the wireless charging receiver.

12. The distance sensing apparatus according to claim 11, wherein the signal is an infrared signal, and an opening is disposed in a center of the second layer, wherein the wireless signal transmitter is disposed in a center of the third layer to transmit the signal through the opening.

13. The distance sensing apparatus according to claim 1, wherein the distance sensing apparatus is a lidar apparatus, the optical distance measuring device is a laser transceiving device, and the rotating device is a combination of a motor and a rotating platform.
